(19) United States
(12) Patent Application Publication
(10) Pub. No.: US 2008/0200667 A1
(43) Pub. Date: Aug. 21, 2008

(54) METHOD FOR PRODUCING CELLULOSE ACYLATE FILM

(75) Inventors: Tomoaki Nagahara, Odawara (JP); Kimito Washiya, Minami-ashigara-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/034,439

(22) Filed: Feb. 20, 2008

(30) Foreign Application Priority Data
Feb. 20, 2007 (JP) 2007-039755

(51) Int. Cl. C08B 3/02

(52) U.S. Cl. 536/63

(57) ABSTRACT

Cellulose with a calcium (Ca) content of at most 10 ppm is used as a raw material of cellulose acylate. The cellulose acylate is synthesized by esterification of cellulose with carboxylic acid such as acetic acid. A dope containing the cellulose acylate and a solvent is continuously cast onto a belt, which is a support, to form a casting film. The casting film is peeled off from the belt as a film, and then the film is dried.

### FIELD OF THE INVENTION

The present invention relates to a method for producing a cellulose acylate film. More specifically, the present invention relates to the cellulose acylate film for use in a liquid crystal display.

### BACKGROUND OF THE INVENTION

Recently, performance of liquid crystal displays (LCDs) is required to be higher. In particular, improvements of performance is demanded to achieve high-luminance and large-sized displays. However, display defects may become easily apparent on such high-luminance and large-sized displays. In other words, improving the luminance and enlarging the size of the display may also make the display defects which have not been noticed enlarged and apparent. The display defect means that the display has a lighted area where the image is not displayed. Such area is called a bright dot.

Cellulose acylate films are often used in optical products such as the LCDs. Impurities contained in the cellulose acylate film, or distortions in the cellulose acylate film deteriorate performance of the optical products, and cause display defects of the LCDs. Particularly with regard to impurities contained in the cellulose acylate film, the probability that a display contains impurities increases with enlargement of the display unless an amount of the impurities contained per a unit area of the cellulose acylate film is reduced. As a result, a yield of the LCD is reduced. In addition, even if the size of the impurities may not be changed, higher-luminance displays make the impurities more apparent as the display defects compared to the conventional displays.

In order to eliminate the display defects of the LCDs, a production method of the cellulose acylate film needs to: (1) reduce impurities contained in cellulose acylate which is a raw material of the cellulose acylate film, (2) reduce an amount of foreign substances mixed into the cellulose acylate film in a producing process of cellulose acylate film, and (3) make a thickness of the cellulose acylate film uniform. Especially, to achieve (3), various suggestions are made in Japanese Patent Laid-Open Publication No. 2003-165866.

To achieve the above (1), for example, Japanese Patent Laid-Open Publication No. 2006-116788 suggests a solution casting method by which a dope containing an organic compound is cast to make a film. The organic compound has reactivity with alkali metal compound and alkaline earth metal compound and has solubility which does not permit precipitation of alkali metal salt and alkaline earth metal salt, generated by the reaction, in the dope.

However, even if the above (1) to (3) are achieved, display defects may be generated on the LCD. With reference to FIG. 3, a formation process of a display defect on an LCD 2 is described. An amount of impurities in cellulose acylate is reduced to a minimum, and a cellulose acylate film 3 is produced from the cellulose acylate by a solution casting method. It is checked that the produced cellulose acylate film 3 has a uniform thickness and does not contain foreign substances. Then, a polyvinyl alcohol (PVA) layer 4 is coated on the cellulose acylate film 3. Although there is no depression on the cellulose acylate film 3, a minute depression 4a is formed on the PVA layer 4. Next, a liquid crystal layer 5 is formed by applying a liquid crystal solution onto the PVA layer 4 and drying it. A depression 5a deeper than the depression 4a is formed on the liquid crystal layer 5 at a position above the depression 4a. When an image is displayed on the produced LCD 2, the depression 5a causes the display defect. In some cases, there are some areas on the cellulose acylate film where the PVA layer 4 and the liquid crystal layer 5 are not formed and the cellulose acylate film may be exposed. Such areas also cause the display defects. The above described depressions 4a and 5a, and the exposure of the cellulose acylate film are called repelling. Causes of the repelling have been considered to be unevenness in thickness of the cellulose acylate film, impurities contained in the cellulose acylate film, and impurities contained in the PVA layer 4 and the liquid crystal layer 5. In other words, it has not been recognized that the repelling does occur even if the cellulose acylate film is impurity-free and has a uniform thickness, and PVA materials and liquid crystal are also impurity-free.

As described above, despite that the cellulose acylate film 2 is impurity-free and has uniform thickness, the depressions 4a and 5a are formed in the PVA layer 4 and the liquid crystal layer 5.

### SUMMARY OF THE INVENTION

In view of the foregoing, an object of the present invention is to provide a producing method of a cellulose acylate film which prevents depressions on a PVA layer and a liquid crystal layer applied to the cellulose acylate film.

In order to achieve the above and other objects, in a producing method of a cellulose acylate film of the present invention, cellulose acylate is synthesized by esterification of cellulose with carboxylic acid. The cellulose has a calcium content of at most 10 ppm. A dope is prepared by dissolving the cellulose acylate in a solvent. A casting film is formed by continuously casting the dope onto a support. The casting film is peeled off from the support and dried.

It is preferable that sulfuric acid is used as a catalyst in the esterification. After the esterification, it is preferable that sulfuric acid and carboxylic acid are neutralized with Ca(OH)₂.

According to the present invention, the cellulose acylate film which prevents the depressions on the PVA layer and the crystal liquid layer applied to the cellulose acylate film is produced.

### BRIEF DESCRIPTION OF THE DRAWINGS

The above objects and advantages of the present invention will become more apparent from the following detailed description when read in connection with the accompanying drawings, in which:

FIG. 1 is a schematic view of a dope producing apparatus;

FIG. 2 is a schematic view of a solution casting apparatus; and

FIG. 3 is a schematic cross-section view of an LCD.

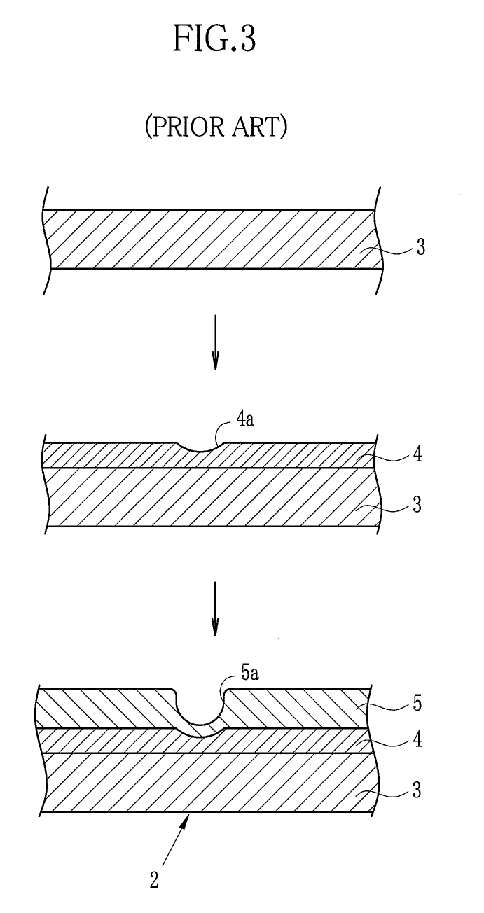

### DETAILED DESCRIPTION OF THE PREFERRED EMBODIMENTS

Hereinafter, embodiments of the present invention are detailed. However, the following embodiments do not limit the scope of the present invention.

### [Raw Materials]

In the present invention, cellulose with a calcium (Ca) content of at most 10 ppm is used as a raw material for cellulose acylate. The parts per million (ppm) of the Ca content is obtained by a mathematical expression {B/(A−B)}×1,000,000 when “A” denotes a mass of cellulose and “B” denotes a mass of Ca contained in the cellulose. The Ca content is measured by a mass spectrometer. With the use of the cellulose having the Ca content of at most 10 ppm as the raw material of the cellulose acylate, a PVA layer, a liquid crystal layer, and the like having uniform thickness are formed on a cellulose acylate film (hereinafter simply referred to as film) without the occurrence of repelling. When such film is used in a display panel of the liquid crystal display (LCD) device, images displayed thereon are of excellent quality. In other words, the LCD devices with fewer display defects than the conventional ones are produced. It is preferable to make the Ca content as low as possible. Although it is industrially difficult, it is most preferable to completely eliminate the Ca from the cellulose.

In production of the LCDs, each manufacturer has its own target yield. In order to achieve the target yield more easily, it is preferable to reduce the number of bright dots on the cellulose acylate film as much as possible. The target value set for the number of the bright dots is approximately not more than 9 per unit area of 1 cm×1 cm on the film for use in the LCD of 15 to 26 inches. The bright dots having a diameter of not less than 10 μm are counted. The above conditions are much stricter than the conventional ones. Depressions are formed on the PVA layer and the liquid crystal layer, which have been applied to the film, above the positions of the bright dots on the film. By checking the presence of the bright dots on the film, the presence of the depressions on the PVA layer and the liquid crystal layer is predicted before the application of the PVA layer and the liquid crystal layer to the film. The positions of depressions on the PVA layer and the liquid crystal layer are also predicted before the application thereof, since the positions of the depressions correspond to the positions of the bright dots. When a graph is made with the Ca content in cellulose along the x-axis and the number of bright dots per unit area along the y-axis, an exponentially increasing curve is depicted. In the graph, the Ca content at the above target value is approximately 10 ppm. Thus, the upper limit, namely, an allowable upper limit value of the Ca content in cellulose is obtained. Thus, the upper limit of the Ca content in cellulose is determined in accordance with the target value of the number of the bright dots.

In this embodiment, cellulose produced in lots is used. The Ca content in the cellulose is measured for each lot. The lot of cellulose having the Ca content of not more than 10 ppm and that having the Ca content of beyond 10 ppm are separated. The lot to be used is selected according to the application. In other words, in order to produce the cellulose acylate film for use in the high-luminance and large-sized display, the cellulose acylate is synthesized from the lot of cellulose having the Ca content of not more than 10 ppm, and the cellulose acylate film is produced from this cellulose acylate.

Similar to the above case where the relationship of the Ca content and the number of the bright dots are examined, plural graphs are made with the content of group 2 representative element(s) other than Ca along the x-axis and the number of the bright dots per a unit area along the y-axis. In the graphs, the number of the bright dots remains approximately constant regardless of the content of the group 2 representative element(s) other than Ca. Therefore, the content of the group 2 representative element(s) other than Ca in cellulose may exceed 10 ppm.

Conventionally, although the lots of cellulose each of which has the same total content of group 2 representative elements are used for producing the films, occurrence of the repelling has not been predictable. Even if the repelling occurs, it will be noticeable only after the application of the cellulose acylate to the film. However, according to the present invention, the repelling is prevented before the application of the PVA layer and liquid crystal layer to the film, and even before the production of the film. Thus, the film is produced without the occurrence of the repelling which is the cause of the bright dots.

Thus, it is preferable to synthesize the cellulose acylate from the cellulose containing only a small amount of Ca. This is because cellulose contains anions which are apt to act particularly on Ca among other group 2 representative elements, and it is difficult to remove the anions from the cellulose, but it is possible to remove Ca from the cellulose.

Repelling frequently occurs in cellulose acylate films produced from wood-derived cellulose. However, wood is more cost efficient and in more sufficient quantity than cotton. According to the present invention, even if the wood-derived cellulose is used, the film for use in the display device with high-luminance and large-sized screen is produced without occurrence of repelling by selecting the lot based on the amount of Ca.

Conventionally, efforts are focused on removal of impurities from the cellulose acylate to prevent repelling. However, the present invention, as described above, prevents repelling regardless of the amount of the impurities contained in cellulose acylate. In order to prevent the repelling, an amount of Ca is examined among other components of cellulose which is the material of cellulose acylate. The repelling is prevented with the use of cellulose with the Ca content of at most a predetermined value.

The above described cellulose is esterified using carboxylic acid and aged, and then dried. Thus, cellulose acylate is synthesized. Sulfuric acid H₂SO₄ is used as a catalyst for esterification reaction. H₂SO₄ and the carboxylic acid are neutralized by calcium hydroxide Ca(OH)₂. Neutralization is performed to prevent hydrolysis of cellulose acylate. The hydrolysis is caused by H₂SO ₄ and carboxylic acid. For this reason, it is preferable that cellulose acylate contains Ca. As described above, it is preferable that cellulose acylate contains Ca, while the Ca content in cellulose is at most 10 ppm. Neutralization may be performed using Mg(OH)₂ instead of or in addition to Ca(OH)₂.

In the cellulose acylate to be used in the present invention, a degree of substitution of hydroxyl group preferably satisfies all of the following formulae (1)-(3):

2.5≦A+B≦3.0 (1)

0≦A≦3.0 (2)

0≦B≦2.9 (3)

In the above formulae, A is the degree of substitution of the hydrogen atom of the hydroxyl group for the acetyl group, and B is a degree of substitution of the hydroxyl group for the acyl group with 3-22 carbon atoms.

The cellulose is constructed of glucose units making β-1,4 combination, and each glucose unit has a free hydroxyl group at second, third and sixth positions. Cellulose acylate is a polymer in which part or whole of the hydroxyl groups are esterified so that the hydrogen is substituted by acyl group with two or more carbons. The degree of substitution for the acyl groups in cellulose acylate is a degree of esterification of the hydroxyl group at second, third or sixth position in cellulose. Accordingly, when all (100%) of the hydroxyl groups at the same position are substituted, the degree of substitution at this position is 1. In the cellulose acylate, when the hydroxyl groups at second, third, and sixth positions are 100% esterified, the degree of substitution is 3.

When the degrees of substitution of the acyl groups for the hydroxyl group at the second, third or sixth positions are respectively described as DS2, DS3 and DS6, the total degree of substitution of the acyl groups for the hydroxyl group at the second, third and sixth positions (namely DS2+DS3+DS6) is preferably in the range of 2.00 to 3.00, particularly in the range of 2.22 to 2.90, and especially in the range of 2.40 to 2.88. Further, DS6/(DS2+DS3+DS6) is preferably at least 0.32, and particularly at least 0.322, and especially in the range of 0.324 to 0.340.

One or more sorts of acyl group may be contained in the cellulose acylate of the present invention. When two or more sorts of the acyl groups are used, it is preferable that one of the sorts is acetyl group. If the total degree of substitution of the acetyl groups for the hydroxyl group and that of acyl groups other than the acetyl group for the hydroxyl group at the second, third or sixth positions are respectively described as DSA and DSB, the value DSA+DSB is preferably in the range of 2.2 to 2.86, and particularly in the range of 2.40 to 2.80. Further, the DSB is preferable to be at least 1.50, and especially at least 1.7. Further, in DSB, the substituent group for the hydroxyl group at the sixth position preferably constitutes not less than 28%. It is more preferable that the substituent group is not less than 30%. It is especially preferable that the substituent group is not less than 31%, and it is most preferable that the substituent group is not less than 32%. Further, the value DSA+DSB at sixth position is preferably at least 0.75, more preferably not less than 0.80, and most preferably not less than 0.85. By the cellulose acylate satisfying the above conditions, a solution (or dope) having a preferable dissolubility, low viscosity, and a high filterability can be prepared. Especially when non-chlorine type organic solvent is used, the cellulose acylate having the above properties is preferable.

The acyl group having at least 2 carbon atoms may be aliphatic group or aryl group, and is not especially restricted. As examples of the cellulose acylate, there are alkylcarbonyl ester, alkenylcarbonyl ester, aromatic carbonyl ester, aromatic alkylcalbonyl ester and the like. Further, the cellulose acylate may be also esters having other substituents. The preferable substituents are propionyl group, butanoyl group, pentanoyl group, hexanoyl group, octanoyl group, decanoyl group, dodecanoyl group, tridecanoyl group, tetradecanoyl group, hexadecanoyl group, octadecanoyl group, iso-butanoyl group, t-butanoyl group, cyclohexane carbonyl group, oleoyl group, benzoyl group, naphtylcarbonyl group, cinnamoyl group and the like. Among them, propionyl group, butanoyl group, dodecanoyl group, octadecanoyl group, t-butanoyl group, oleoyl group, benzoyl group, naphtyl carbonyl group, cinnamoyl group and the like are particularly preferable, and propionyl group and butanoyl group are especially preferable.

It is preferable that not less than 90 wt. % of cellulose acylate, which is the raw material of the dope, is in the form of particles having particle diameters of 0.1 mm to 4 mm.

Details of cellulose acylate are described in paragraphs [0140]-[0195] in Japanese Patent Laid-Open Publication No. 2005-104148. The above descriptions can be applied to the present invention.

Solvents and additives such as plasticizers, deterioration inhibitors, UV absorbents, optical anisotropy controllers, dyes, matting agents, and peeling agents are also described in paragraphs [0196]-[0516] in the above Japanese Patent Laid-Open Publication No. 2005-104148. The above descriptions can also be applied to the present invention.

Examples of the solvents used for producing the dope are aromatic hydrocarbon (for example, benzene toluene and the like), halogenated hydrocarbons (for example, dichloromethane, chlorobenzene and the like), alcohols (for example methanol, ethanol, n-propanol, n-butanol, diethylene glycol and the like), ketones (for example acetone, methylethyl ketone and the like), esters (for example, methylacetate, ethylacetate, propylacetate and the like), ethers (for example tetrahydrofuran, methylcellosolve and the like) and the like. The dope is a polymer solution or a polymer dispersion liquid obtained by dissolving or dispersing polymer(s) in a solvent.

Among the above solvents, the halogenated hydrocarbons having 1 to 7 carbon atoms are preferable and dichloromethane is especially preferable as a solvent for cellulose acylate such as cellulose triacetate (TAC). In view of physical properties such as solubility of TAC, peelability of a casting film from a support, a mechanical strength, optical properties of the film and the like, it is preferable to mix at least one sort of the alcohol having 1 to 5 carbon atoms into the halogenated hydrocarbons. The content of the alcohols is preferably in the range of 2 wt. % to 25 wt. %, and more preferably in the range of 5 wt. % to 20 wt. % of total solvent compounds in the solvent. Specific examples of the alcohols are methanol, ethanol, n-propanol, isopropanol, n-butanol, and the like. It is preferable to use methanol, ethanol, n-butanol or a mixture thereof.

In order to reduce the influence on the environment to a minimum, a dope may be prepared without dichloromethane. In this case, ethers with 4 to 12 carbon atoms, ketones with 3 to 12 carbon atoms, and esters with 3 to 12 carbon atom are preferable as the solvent. It is also possible to use a mixture of them. The ethers, ketones, and esters may have cyclic structure. Compounds having at least two of the above functional groups thereof (namely, —O—, —CO—, and —COO—) maybe used as the solvent. Note that the solvent compound may have other functional group such as alcoholic hydroxyl group in the chemical structure.

[Dope Producing Method]

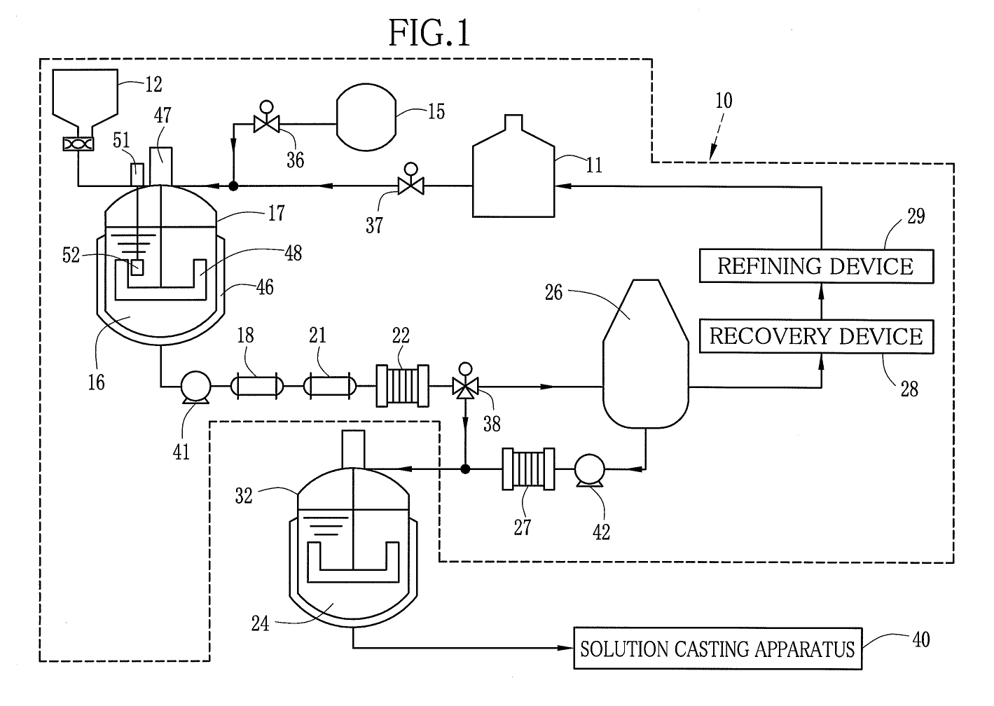

In FIG. 1, a dope producing apparatus 10 has a solvent tank 11, a hopper 12, an additive tank 15, a mixing tank 17, a heater 18, a temperature controller 21, a filtration device 22, a flash unit 26, and a filtration device 27. The solvent tank 11 stores a solvent. The hopper 12 supplies cellulose acylate. The additive tank 15 stores an additive. The mixing tank 17 mixes the solvent, cellulose acylate, and the additive to make a mixture 16 which is in the liquid state. The heater 18 heats the mixture 16. The temperature controller 21 adjusts the temperature of the heated mixture 16. The filtration device 22 filters the mixture 16 sent from the temperature controller 21. The flash unit 26 adjusts concentration of a dope 24 sent from the filtration device 22. After the adjustment of the concentration, the filtration device 27 filters the dope 24. The dope producing apparatus 10 further includes a recovery device 28 for recovering the solvent and a refining device 29 for refining the recovered solvent. The dope producing apparatus 10 is connected to a solution casting apparatus 40 through a stock tank 32. Valves 36 to 38 for adjusting liquid feeding amounts, and pumps 41 and 42 for feeding liquids are also provided in the dope producing apparatus 10. Positions and the number of the pumps may be changed as necessary.

The dope 24 is produced using the dope producing apparatus 10 as described in the following. By opening the valve 37, the solvent is fed from the solvent tank 11 to the mixing tank 17. Next, cellulose acylate is fed from the hopper 12 to the mixing tank 17. Cellulose acylate may be fed constantly to the mixing tank 17 using a feeding device (not shown) which constantly measures the amount of the cellulose acylate while feeding it. Alternatively, cellulose acylate may be fed intermittently to the mixing tank 17 using a feeding device (not shown) which feeds a predetermined amount at a time after measuring the amount of the cellulose acylate. By opening and closing the valve 36, a necessary amount of the additive solution is fed from the additive tank 15 to the mixing tank 17.

The additive may be fed in the state of a solution. In the case the additive is in a liquid state at room temperature, the additive may be fed to the mixing tank 17 in the liquid state. In the case the additive is in a solid state, the additive may be fed to the mixing tank 17 using a hopper or the like. In the case a plurality of additives are added, a solution in which the additives are dissolved may be put in the additive tank 15. Alternatively, a plurality of additive tanks may be used. In this case, each additive tank contains a solution in which an additive is dissolved. Each additive tank is individually connected to the mixing tank 17 through a pipe to feed the solution.

As described above, the solvents, cellulose acylate, and the additives are put in the mixing tank 17 in this order. However, the order is not limited to the above. The additive is not necessarily mixed to the cellulose acylate and the solvent in the mixing tank 17. The additive may be mixed to a mixture of cellulose acylate and the solvent by an inline mixing method in a subsequent process.

It is preferable that the mixing tank 17 is provided with a jacket 46, a first stirrer 48, and a second stirrer 52. The jacket 46 covers an outer surface of the mixing tank 17. A heat transfer medium is supplied to a space between the jacket 46 and the mixing tank 17. The first stirrer 48 is rotated by a motor 47. The second stirrer 52 is rotated by a motor 51. The temperature of the mixing tank 17 is adjusted by the heat transfer medium, and a preferable temperature range is −10° C. to 55° C. The mixture 16 in which the cellulose acylate is swelled by the solvent is formed by selectively using the first stirrer 48 and the second stirrer 52. It is preferable that the first stirrer 48 has an anchor blade, and the second stirrer 52 is an eccentric stirrer of a dissolver type.

Next, the mixture 16 is fed to the heater 18 using the pump 41. It is preferable that the heater 18 is a pipe (not shown) with the jacket. A heat transfer medium is passed between the pipe and the jacket. In addition, it is preferable that the heater 18 has a pressurized section (not shown) for pressurizing the mixture 16. With the use of the heater 18, solid contents in the mixture 16 are effectively and efficiently dissolved under a heated condition, or a pressurized and heated condition. Hereinafter, a method in which the solid contents are dissolved in the solvent by heating is referred to as a heat-dissolving method. In the heat-dissolving method, it is preferable to heat the mixture in a range of 0° C. to 97° C.

Alternatively, a cool-dissolving method may be used. The cool-dissolving method is a method by which dissolution of the solid contents is advanced while the temperature of the mixture 16 is kept at a predetermined value or cooled to a low temperature. In the cool-dissolving method, it is preferable to cool the mixture 16 in a range of −100° C. to −10° C. With the use of the above heat-dissolving method or the cool-dissolving method, cellulose acylate is sufficiently dissolved in the solvent.

After the temperature of the mixture 16 is adjusted at an approximate room temperature, the mixture 16 is filtered through the filtration device 22 to remove foreign substances such as impurities and aggregations. Hereinafter, the mixture 16 is referred to as the dope 24. An average pore diameter of the filter for use in the filtration device 22 is preferably not more than 100 μm. It is preferable that a filtration flow rate is not less than 50 liter/hr.

After the filtration, the dope 24 is fed to the stock tank 32, through the valve 38, and temporarily stored therein, and then used for the film production.

As described above, the method by which solid contents are swelled and then dissolved to make a solution needs longer time for dope preparation especially when the concentration of cellulose acylate in the solution is increased. Such method has a problem in production efficiency. In this case, it is preferable to prepare a dope having a lower concentration than the intended concentration of the dope, and then concentrate the dope to the intended concentration. For example, the dope 24 is fed to the flash unit 26 after the filtration through the filtration device 22, and a part of the solvent of the dope 24 is evaporated for concentration. The concentrated dope 24 is suctioned from the flash unit 26 through the pump 42 and fed to the filtration device 27. It is preferable that the temperature of the dope 24 is in a range 0° C. to 200° C. at the time of filtration. The dope 24, from which foreign substances are removed through the filtration device 27, is fed to the stock tank 32 and temporarily stored therein. Thereafter, the dope 24 is used for the film production. Since the concentrated dope 24 may contain foam, it is preferable to perform defoaming before the dope 24 is fed to the filtration device 27. Various known defoaming methods may be used, for example, a method to radiate ultrasound to the dope 24, and the like.

The solvent vapor generated by flash evaporation in the flash unit 26 is condensed in the recovery device 28 having a condenser (not shown). Thereby, the solvent vapor is condensed into a liquid and recovered. The recovered solvent is refined as a solvent in the refining device 29, and reused in the dope production. Such recovering and refining of the solvent vapor are advantageous in production cost. Since recovering and refining are performed in a closed system, adverse effects to humans and environment are prevented.

Thus, the dope 24 having cellulose acylate concentration of 5 wt % to 40 wt % is produced. It is more preferable that the cellulose acylate concentration is not less than 15 wt. % and not more than 30 wt. %. It is furthermore preferable that the cellulose acylate concentration is not less than 17 wt. % and not more than 25 wt. %. It is preferable that the concentration of the additive is not less than 1 wt. % and not more than 20 wt. % with respect to a total solid content.

Materials, raw materials, and dissolving methods of additives, filtration methods, defoaming, and adding methods in the solution casting method to produce TAC film are detailed in paragraphs [0517] to [0616] of Japanese Patent Laid-Open Publication No. 2005-104148. The above descriptions may also be applied to the present invention.

[Film Producing Method]

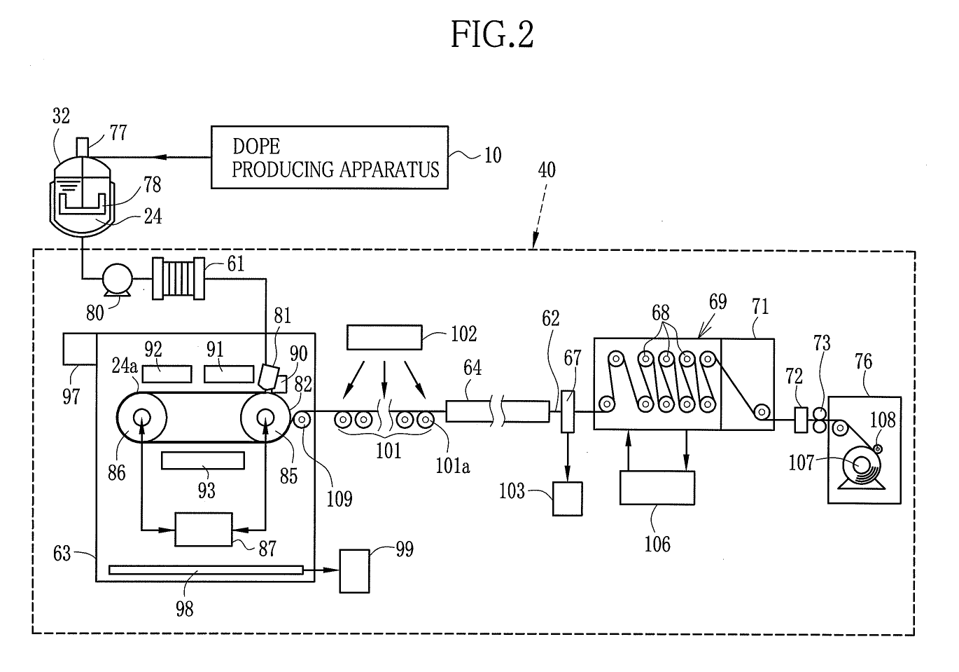

In FIG. 2, the solution casting apparatus 40 has a filtration device 61, a casting chamber 63, a tenter 64, an edge-slitting device 67, a drying chamber 69, a cooling chamber 71, a neutralization device 72, a pair of knurling rollers 73, and a winding chamber 76. The filtration device 61 removes foreign substances from the dope 24 fed from the stock tank 32. In the casting chamber 63, the filtered dope 24 is cast to form a cellulose acylate film (hereinafter simply referred to as a film) 62. The tenter 64 holds both side edge portions of the film 62 and dries the film 62 while conveying it. The edge-slitting device 67 cuts off the both side edges of the film 62. In the drying chamber 69, the film 62 is bridged across a plurality of rollers 68. The film 62 is dried while being conveyed through the drying chamber 69. In the cooling chamber 71, the film 62 is cooled. The neutralization device 72 reduces charged voltage of the film 62. The pair of knurling rollers 73 provides knurling to both side edge portions of the film 62 by embossing. The film 62 is wound in the winding chamber 76.

A stirrer 78 rotated by a motor 77 is attached to the stock tank 32. The dope 24 is stirred with the rotation of the stirrer 78. The dope 24 in the stock tank 32 is fed to the filtration device 61 using a pump 80.

The casting chamber 63 has a casting die 81 for casting the dope 24 and a belt 82 which is a moving support. Two-phase stainless steel or precipitation hardening stainless steel is preferable as thematerial of the castingdie 81. It is preferable that the material has coefficient of thermal expansion of at most 2×10⁻⁵(°C.⁻¹). It is preferable that the material has the almost same anti-corrosion properties as SUS316 in examination of corrosion in electrolyte solution. Further, the material has the anti-corrosion properties which do not form pitting (holes) on the gas-liquid interface after having been dipped in a liquid mixture of dichloromethane, methanol and water for three months. It is preferable that the casting die 81 is formed by grinding a material which passed more than a month after casting. With the use of such material, the dope 24 flows through the casting die 81 uniformly, and streaks in the casting film 24a are prevented. It is preferable that the finish precision of a contacting surface of the casting die 81 contacting the dope 24 is at most 1 μm, and the straightness is at most 1 μm/m in any direction. The clearance of the slit is automatically controlled in a range of 0.5 mm and 3.5 mm. The end of the contacting portion of each lip to the dope 24 is processed so as to have the chamfered radius at most 50 μm throughout the slit. Further, it is preferable to adjust the shearing speed inside the casting die 81 in the range of 1 (1/sec) to 5000 (1/sec) The casting die 81 of a coat hanger type is preferable.

A width of the casting die 81 is not particularly limited. However, it is preferable that the width of the casting die 81 is in a range of 1.1 times and 2.0 times larger than the width of the film 62 as an end product. To maintain the temperature of the dope 24 at a predetermined value during the film production, it is preferable to install a temperature controller (not shown) to the casting die 81 for controlling the temperature of the casting die 81. In addition, it is preferable that the casting die 81 is provided with bolts (heat bolts) which adjust the size of the slit of the casting die 81 so as to adjust the thickness of a casting bead discharged from the casting die 81. The casting bead is the dope 24 between the casting die 81 and the belt 82. It is preferable that the heat bolts are provided at predetermined intervals in the width direction of the slit. It is also preferable that the heat bolts are controlled by an automatic thickness adjusting mechanism. It is preferable to set the profile of the slit according to the flow volume of the pump 80 based on the previously set program. It is preferable that the pump 80 is a high precision gear pump so as to precisely control the flow volume of the dope 24. It is also possible to provide a thickness measuring device such as an infrared thickness gauge in the solution casting apparatus 40. In this case, the feedback control of the automatic thickness adjusting mechanism is performed based on the adjusting program according to the thickness profile of the film 62 and the detection results of the thickness measuring device. The casting die 81 is capable of adjusting the slit of the lip end by ±50 μm such that a difference in thickness between two given points on the film 62 is preferably adjusted within 1 μm except for the side edge portion of the film 62 as the end product.

Further, it is more preferable that the lip ends of the casting die 81 are provided with a hardened layer. Forming methods of the hardened layer are not particularly limited. For example, ceramics coating, hard chrome plating, nitriding treatment and the like may be used. When ceramics are used as the hardened layer, it is preferable that the ceramics are grindable but not friable, and have a lower porosity and the good corrosion resistance, and lack affinity for and do not stick to the dope 24. Examples of ceramics are tungsten carbide (WC), Al₂O₃, TiN, Cr₂O₃ and the like, and WC is especially preferable. The hardened layer is formed by a WC coating in a spraying method.

The dope 24 may be partially dried and become solid at the lip ends of the casting die 81. In order to prevent such solidification of the dope 24, a solvent supplying device (not shown) is installed in the proximity of the lip ends for supplying a solvent to the lip ends. It is preferable that the solvent is supplied to around three-phase contact lines where the casting bead, the lip end and air meet. It is preferable that the flow volume of the solvent supplied to each side edge of the slit of the casting die 81 is in a range of 0.1 ml/min to 1.0 ml/min. The solvent which solubilizes the dope 24 is used. In the case the solid content of the dope is mainly composed of cellulose acylate, the solvent is preferably a mixture of, for example, 86.5 parts wt. of dichloromethane, 13 parts. wt. of methanol, 0.5 parts wt. of n-butanol. Thereby, contamination of the dope 24 with foreign substances such as solid contents precipitated from the dope 24 and with foreign substances mixed to the casting bead is prevented. It is preferable to use the pump with a pulsation of 5% or less for supplying the solvent.

The belt 82 located below the casting die 81 is bridged across rollers 85 and 86. The belt 82 is constantly driven by the rotation of at least one of the rollers 85 and 86.

A width of the belt 82 is not particularly limited. It is preferable that the width of the belt 82 is in a range of 1.1 times to 2.0 times of the casting width of the dope 24. The length of the belt 82 is preferably in a range of 20 m to 200 m. The thickness of the belt 82 is preferably in a range of 0.5 mm to 2.5 mm. It is preferable that the surface of the belt 82 is polished such that a surface roughness is at most 0.05 μm.

It is preferable that a heat transfer medium circulation device 87 is attached to the rollers 85 and 86. The heat transfer medium circulation device 87 supplies a heat transfer medium to the rollers 85 and 86 to control the surface temperatures of the rollers 85 and 86. In this embodiment, paths (not shown) for the heat transfer medium are formed inside the rollers 85 and 86. The heat transfer medium which is kept at a predetermined temperature passes through the paths to maintain the surface temperatures of the rollers 85 and 86 at a predetermined value. The surface temperature of the belt 82 is set in accordance with types of the solvent, types of the solid contents, concentration of the dope 24, and the like.

Instead of using the belt 82 and the rollers 85 and 86, a drum (not shown) may be used as a support. In this case, it is preferable to use a drum capable of rotating in high precision such that not more than 0.2% of the rotation speed is permitted as rotation speed variation. The surface roughness of the drum is preferably not more than 0.01 μm. It is preferable that the surface of the drum is chrome plated. Thereby, sufficient hardness is provided and durability is improved. The surfaces of the drum, the belt 82, and the rollers 85 and 86 are preferably defect-free. To be more specific, the number of pin holes whose diameter is more than 30 μm is preferably zero. The number of pinholes whose diameter is not less than 10 μm and less than 30 μm is preferably 1 or less per 1 m². The number of pinholes whose diameter is less than 10 μm is 2 or less per 1 m².

It is preferable to install a decompression chamber 90 in the proximity of the casting die 81 so as to control pressure of the upstream side from a casting bead, which is the dope 24 between the casting die 81 and the belt 82, with respect to a moving direction of the belt 82.

Air blowers 91 to 93 are installed in the proximity of the belt 82. The air blowers 91 to 93 feed dry air toward the proximity of the casting film 24a. In the casting chamber 63, a temperature controller 97 and a condenser 98 are installed. The temperature controller 97 maintains an inner temperature of the casting chamber 63 at a predetermined value. The condenser 98 condenses and recovers the organic solvent vapor. A recovery device 99 for recovering the condensed organic solvent is provided outside the casting chamber 63.

An air blower 102 is installed in a transfer section 101 in the downstream from the casting chamber 63. A crusher 103 is installed in the edge-slitting device 67. The crusher 103 crushes the cut-off side edges of the film 62 into chips.

A recovery device 106 of adsorbing type is installed in the drying chamber 69. The recovery device 106 adsorbs and recovers a solvent vapor evaporated from the film 62. The cooling chamber 71 is provided in the downstream from the drying chamber 69. A moisture control chamber (not shown) for adjusting water content of the film 62 may be installed between the drying chamber 69 and the cooling chamber 71. The neutralization device 72 is a so-called compulsory neutralization device such as a neutralization bar, and the like, and adjusts charged voltage of the film 62 in a predetermined range. An installation position of the neutralization device 72 is not limited to the downstream side from the cooling chamber 71. Inside the winding chamber 76, a winding shaft 107 and a press roller 108 are provided. The winding shaft 107 winds the film 62. The press roller 108 controls tension of the film 62 at the time of winding.

Next, an example of production methods of the film 62 is described. The dope 24 is fed to the stock tank 32, and constantly kept uniform by the rotation of the stirrer 78. Thereby, precipitation and aggregation of solid contents are suppressed until the casting of the dope 24. Various additives may be mixed to the dope 24 as necessary during the stirring. Foreign substances having a larger particle diameter than a predetermined size and those in gel state are removed by filtration through the filtration device 61.

The dope 24 after the filtration is cast from the casting die 81 to the belt 82. It is preferable that the temperature of the dope 24 at the casting is constant in a range of −10° C. to 57° C. It is preferable that the surface temperature of the belt 82 is constant in a range of −20° C. to 40° C. Relative positions of the rollers 85 and 86, and a rotation speed of at least one of the rollers 85 and 86 are adjusted so as make a tension to the belt 82 to be 10⁴ N/m×10⁵ N/m. The difference of the relative speed the belt 82 and the rollers 85 and 86 is preferably 0.01 m/min or less. The speed fluctuation of the belt 82 is 0.5% or less. The positional fluctuation of the belt 82 in the widthwise direction per one rotation, namely, meandering is regulated to be 1.5 mm or less. In order to prevent the meandering, it is preferable to perform feedback control of the position of the belt 82 by providing a detector (not shown) for detecting positions of side edges of the belt 82 and a position adjusting device (not shown) for adjusting the position of the belt 82 in response to a detection data from the detector. The positional fluctuations in vertical directions of the belt 82 just below the casting die 81 are preferably adjusted to be 200 μm or less. A temperature inside the casting chamber 63 is preferably adjusted in a range of −10° C. to 57° C. by the temperature controller 97. The solvent vapor in the casting chamber 63 is recovered by the recovery device 99, and then refined. The refined solvent is reused as a solvent for dope preparation.

The casting bead is the dope 24 between the casting die 81 and the belt 82. The casting film 24a is formed on the belt 82. To stabilize the condition of the casting bead, pressure of an area upstream from the casting bead with respect to the moving direction of the belt 82 is controlled by the decompression chamber 90 at a predetermined pressure. It is preferable that the pressure of the area upstream from the casting bead is adjusted to be lower than that of the area downstream from the casting bead by 2000 Pa to 10 Pa. It is preferable to install a jacket (not shown) around the decompression chamber 90 to keep the inner temperature of the decompression chamber 90 at a predetermined value. It is preferable that the inner temperature is equal to or above a condensation temperature of the solvent of the dope. In order to keep the casting bead in a desired shape and condition, an edge suction device (not shown) is preferably installed at side edge portions of the casting die 81 to keep the casting bead in a desired shape. An edge suction flow rate is preferably in a range of 1 liter/min to 100 liter/min.

Upon obtaining a self supporting property, the casting film 24a is peeled off from the belt 82 while being supported by a peel roller 109. A weight of the remaining solvent in the casting film 24a at the time of peeling is preferably 20 to 250 when the weight of solid contents is regarded as 100. The film 62 containing the solvent is conveyed through the transfer section 101 while being supported by a plurality of rollers 101a and fed to the tenter 64. In the transfer section 101, a draw tension may be imparted to the film 62 by making the rotation speed of downstream rollers faster than that of upstream rollers. In the transfer section 101, dry air at a predetermined temperature is fed from the air blower 102 toward an area in the proximity to the film 62 or directly toward the film to promote drying of the film 62. At this time, it is preferable that the temperature of the dry air is in a range of 20° C. to 250° C.

The film 62 is sent to the tenter 64. In the tenter 64, the film 62 is dried while being conveyed with its both side edge portions held by clips 64a. Alternatively, it is also possible to use pins which pierce and hold the film 62. It is preferable that the tenter 64 is divided into sections in a conveying direction and a temperature in each section is adjusted at an appropriate value. The tenter 64 is capable of stretching the film 62 in a widthwise direction. It is preferable that the film 62 is stretched in at least one of the casting direction and the widthwise direction in at least one of the transfer section 101 and the tenter 64 by 100.5% to 300% with respect to the size of the film 62 before stretching.

The film 62 is dried in the tenter 64 until the remaining solvent reaches a predetermined value. Thereafter, the both side edge portions are cut off by the edge-slitting device 67. The cut-off side edge portions are sent to the crusher 103 by a cutter blower (not shown). The crusher 103 crushes the side edge portions into chips. The chips are reused for preparation of the dope, and thus the materials are efficiently reused. The cutting process of the side edge portions may be omitted. However, it is preferable to perform the cutting process between the casting process and the winding process of the film.

On the other hand, the film 62 with its both side edge portions cut off, is sent to the drying chamber 69, and further dried. In the drying chamber 69, the film 62 is conveyed while being bridged across the rollers 68. An inner temperature of the drying chamber 69 is not particularly limited. However, a temperature in a range of 50° C. to 160° C. is preferable. It is preferable that the drying chamber 69 is divided into sections so as to change the feeding air temperature in each section. In addition, a predrying chamber (not shown) may be provided between the edge-slitting device 67 and the drying chamber 69. By predrying the film 62 in the predrying chamber, an abrupt increase of the film temperature in the drying chamber 69 is prevented. Thereby, changes in the shape of the film 62 in the drying chamber 69 are prevented. The solvent vapor evaporated from the film 62 in the drying chamber 69 is adsorbed and recovered by the recovery device 106. Air from which the solvent component is removed is sent inside the drying chamber 69 as dry air.

The film 62 is cooled to approximate room temperature in the cooling chamber 71. In the case a moisture control chamber is disposed between the drying chamber 69 and the cooling chamber 71, it is preferable to blow air, whose moisture and temperature are adjusted at appropriate values, onto the film 62 in the moisture control chamber. Thus, curling of the film 62 and winding defects at the time of winding the film 62 are prevented.

In the solution casting method, various processes such as drying process and cutting process of the side edge portions are performed between peeling off of the film 62 from the support and winding of the film 62. In each process or between each process, the film 62 is supported or conveyed mainly by rollers. There are drive rollers and non-drive rollers. The non-drive rollers are mainly used for determining the conveying path of the film 62, and improving stability of film conveyance.

The charge voltage of the film 62 during conveyance is controlled at an appropriate value using the neutralization device 72. The charged voltage after the neutralization is preferably −3 kV to +3 kV. It is preferable to provide knurling to the film 62 with the use of the pair of knurling rollers 73. It is preferable that a knurling groove depth is 1 μm to 200 μm.

The film 62 is wound around the winding shaft 107 in the winding chamber 76. It is preferable to apply an appropriate tension to the film 62 using the press roller 108 while the film 62 is being wound. It is preferable to gradually change the tension between the start and the end of the winding. Thus, an excess tightening of the film roll is prevented. It is preferable that a length of the film 62 to be wound is not less than 100 m in the casting direction. A width of the film 62 to be wound is preferably not less than 600 mm, and preferably in a range of 1400 mm and 1800 mm. The present invention can also be applied to a film having a width larger than 1800 mm. The present invention can also be applied to production of a thin film with a thickness of not less than 15 μm and not more than 80 μm.

In the present invention, two or more kinds of dopes may be simultaneously co-cast by a simultaneous co-casting method, or sequentially co-cast by a sequential co-casting method. When the simultaneous co-casting is performed, a casting die with a feed block or a casting die of a multi-manifold type may be used. A thickness of at least one of surface layers, which are exposed to air, of a multilayer film produced by co-casting preferably constitute 0.5% to 30% of the total thickness of the multilayer film. In the co-casting method, it is preferable to adjust concentration of each dope such that the lower viscosity dopes may entirely cover over the higher viscosity dope when the dope is cast onto the support from a die slit. Furthermore, with regard to the casting bead formed between the die slit and the support in the simultaneous co-casing method, it is preferable that an outer dope (outer casting bead) exposed to air contains a higher ratio of a poor solvent than inner dopes (inner casting beads).

Paragraphs from [0617] to [0889] of Japanese Patent Laid-Open Publication No. 2005-104148 describe in detail the structures of the casting die, the decompression chamber and the support, co-casting, peeling, stretching, drying condition in each process, a handling method, curling, a winding method after the correction of planarity, a recovering method of the solvent, and a recovering method of film. The above descriptions may be applied to the present invention.

[Characteristics, Measuring Method]

(Curling Degree and Thickness)

Paragraphs from [0112] to [0139] of the Japanese Patent Laid-Open Publication No. 2005-104148 describe properties of the cellulose acylate film and the measuring methods thereof. The above descriptions may be applied to the present invention.

[Application]

The cellulose acylate film is effectively used as the protective film for a polarizing filter. Cellulose acylate film is adhered to a polarizer to form the polarizing filter. The LCD normally has a structure in which a liquid crystal layer is sandwiched between two polarizing filters. The configuration of the liquid crystal layer and the polarizing filters are not restricted in the above example and other known configurations can be used. Japanese Patent Laid-Open Publication No. 2005-104148 discloses TN type, STN type, VA type, OCB type, reflection type, and other examples of the LCD devices in detail. These types can be applied to the film of the present invention. Further, the above publication teaches the cellulose acylate film provided with an optical anisotropic layer and that provided with antireflective and antiglare functions. Furthermore, the above publication discloses the cellulose acylate film provided with appropriate optical functions, namely, a biaxial cellulose acylate film which is used as the optical compensation film. The above films may also serve as the protective film in the polarizing filter. The above descriptions may be applied to the present invention. Details are described in paragraphs from [1088] to [1265] in Japanese Patent Laid-Open Publication No. 2005-104148.

### EXAMPLE

Next, an example of the present invention is described. The dope 24 of the following composition was prepared.

[Raw materials and compounding ratio of the dope 24]

| | |
|---|---|
| Cellulose triacetate (TAC) | 100 pts. wt. |
| (degree of substitution was 2.86 (acetylation | |
| degree was 60.8%), Mw/Mn = 2.7, viscometric | |
| average degree of polymerization was 305, viscosity | |
| of 6 wt. % of dichloromethane solution was | |
| 350 mPa · s) | |
| Dichloromethane (first component of the solvent) | 320 pts. wt. |
| Methanol (second component of the solvent) | 83 pts. wt. |
| 1-Butanol | 3 pts. wt. |
| Plasticizer A | 7.6 pts. wt. |
| Plasticizer B | 3.8 pts. wt. |
| UV agent a: | |
| 2-(2′-hydroxy-3′,5′-di-tert-butylphenyl) benzotriazol | 0.7 pts. wt. |
| UV agent b: | |
| 2-(2′-hydroxy-3′,5′-di-tert-amylphenyl)-5- | 0.3 pts. wt. |
| chlorobenzotriazol | |
| Citric acid ester mixture (a mixture of citric acid, citric | 0.006 pts. wt. |
| acid monoethyl ester, citric acid diethyl ester and | |
| citric acid triethyl ester) | |
| Fine particles (silicon dioxide, average particle diameter: | 0.05 pts. wt. |
| 15 nm, Mohs hardness: approximately 7) | |

The above plasticizer A was triphenylphosphate (TPP) and the plasticizer B was biphenyl diphenyl phosphate (BDP).

In each of Experiments 1 to 3 and Comparative experiments 1 and 2, TAC with different Ca content and/or Mg content was used. TAC is synthesized from cellulose. The Ca contents and Mg contents of cellulose are shown in Table 1.

[Dope Preparation]

The dope 24 was prepared using the dope producing apparatus 10 shown in FIG. 1. The above described two solvents, namely, dichloromethane and methanol were mixed and stirred in the 4000 liter solvent tank 11 made of stainless steel having the stirring blade to form a solvent mixture. Each of the above solvent components had water content of not more than 0.5 wt. %. Next, TAC flakes were gradually fed from the hopper 12 to the mixing tank 17. TAC was dispersed for 30 minutes under appropriate conditions by the eccentric stirrer 48 of the dissolver type having the anchor blade on the rotation axis. The temperature at the start of the dispersion was 25° C., and the temperature at the end of the dispersion was 48° C. An additive solution, which was formed by previously mixing the above additive components of the above raw materials, was fed from the additive tank 15 to the mixing tank 17 such that the total amount of the additive solution in the mixing tank 17 became 2000 kg. After the dispersion of the additive solution, high-speed stirring was stopped. Thereafter, a peripheral speed of the anchor blade was set at an appropriate value and stirring was continued for 100 minutes. Thereby, TAC flakes were swelled and the mixture 16 became a swelling liquid. Until the completion of swelling, inside the mixing tank 17 was pressurized with nitrogen gas to maintain 0.12 MPa. At this time, oxygen concentration inside the mixing tank 17 was less than 2 vol %, and made explosion proof. The water content of the mixture 16 was 0.3 wt. %.

[Dissolution and Filtration]

The mixture 16 was fed from the mixing tank 17 to the heater 18, which was the pipe with the jacket, using the pump 41. The heater 18 heated the mixture 16 to 50° C., and then up to 90° C. while pressure of 2 MPa was applied to the mixture 16. Thereby, the mixture 16 was completely dissolved. The heating time was 15 minutes. Next, temperature of the dissolved liquid was lowered to 36° C. using the temperature controller 21. Then, the dissolved liquid was passed through the filtration device 22 having a filter with a nominal pore diameter of 8 μm. At that time, a primary pressure of the filtration device 22 was 1.5 MPa and the secondary pressure of the filtration device 22 was 1.2 MPa. The filter, the housing, and the pipe, which were exposed to high temperature, were made of hastelloy alloy to be superior in corrosion resistance, and provided with jackets in which a heat transfer medium was circulated for insulation and heating. The solid content of produced dope 24 was 19%.

Next, foam was removed by irradiating weak ultrasonic waves to the dope 24. Thereafter, the dope 24 passed through the filtration device 27 with the use of the pump while pressure of 1.5 MPa was applied to the dope 24. In the filtration device 27, the dope 24 passed through a sintered metal fiber filter (of a grade 06N, produced by Nippon Seisen Co., Ltd.) with a nominal pore diameter of 10 μm, and then the other sintered metal fiber filter of the same size (the pore diameter of 10 μm). Primary pressures applied to the sintered metal fiber filters were 1.5 MPa and 1.2 MPa respectively. Secondary pressures were 1.0 MPa and 0.8 MPa respectively. The temperature of the dope 24 after the filtration was kept at 36° C. and stored in the 2000 liter stainless steel stock tank 32. The stock tank 32 had the stirrer 78 in which the anchor blade was attached to the rotation axis. The stirrer 78 constantly stirred the dope 24 in the stock tank 32. In the above dope producing apparatus, corrosion and the like did not occur to devices and members contacting the dope.

[Discharging, Casting, Decompression of Casting Bead]

The film 62 was produced using the solution casting apparatus 40 shown in FIG. 2. The dope 24 was fed to the filtration device 61 using the high precision gear pump 80. The pump 80 has a function to increase the primary pressure thereof. A feedback control was performed to the upstream from the pump 80 with the use of an inverter motor such that the primary pressure of the pump 80 reached 0.8 MPa. The pump 80 had volume efficiency of 99.2%, and the fluctuation ratio of discharge amount was 0.5% or less. The discharge pressure was 1.5 MPa. After the filtration through the filtration device 61, the dope 24 was fed to the casting die 81.

A flow volume of the dope 24 at a discharge port of the casting die 81 was adjusted for casting such that a thickness of the film 62 after drying became 100 μm. To maintain the temperature of the dope 24 at a predetermined value, a jacket (not shown) was provided to the casting die 81, and the temperatures of the casting die 81 and the pipe were maintained at a predetermined value by setting a temperature of a heat transfer medium fed through the jacket at a predetermined value.

The casting die 81 was of a coat hanger type. On the upstream side of the casting die 81 with respect to the moving direction of the belt 82, the decompression chamber 90 was installed to decompress the upstream side of the bead with respect to the moving direction of the belt 82. A pressure difference was set between the upstream side and the downstream side of the casting bead so as to make the length of the casting bead at a predetermined value. The decompression chamber 90 had a mechanism which was capable of setting a temperature higher than a condensation temperature of a gas around the casting portion. Labyrinth packing (not shown) was provided at the front and the back portions of the discharge port of the casting die 81. An opening was provided to each of the both side edges of the discharge port. The pressure of the upstream side from the casting bead was adjusted to be lower than that of the downstream side from the casting bead with the use of the decompression chamber 90. A jacket (not shown) was attached to the decompression chamber 90 so as to make the inner temperature thereof constant at the predetermined value. A heat transfer medium adjusted at a predetermined temperature was supplied inside the jacket. The edge suction device (not shown) was attached to the casting die 81 so as to reduce fluctuations of both side edges of the casting bead.

[Casting Die]

The material of the casting die 81 was a two-phase stainless steel having coefficient of thermal expansion of at most 2×10⁻⁵(° C.⁻¹), the almost same anti-corrosion properties as SUS316 in examination of corrosion in electrolyte solution. Further, the material has the anti-corrosion properties which do not form pitting (holes) on the gas-liquid interface after having been dipped in a liquid mixture of dichloromethane, methanol and water for three months. The surface roughness of the portion contacting the dope, straightness of the casting die 81, and a chamfered radius R of the lip ends, which comes in contact with the dope 24, of the casting die 81 satisfy predetermined values. A hardened layer was applied to the lip ends of the casting die 81. The hardened layer was applied by WC (tungsten carbide) coating of a spraying method.

In order to prevent the partial solidification of the dope 24 at the discharge port of the casting die 81, a solvent of a predetermined amount was supplied to both edges of the discharge port, with which the dope 24 comes in contact, through a pump.

[Belt]

The belt 82 made of stainless steel was previously polished to achieve a predetermined thickness and surface roughness. The material of the belt 82 was SUS316 which offers sufficient corrosion resistance and strength. A tension of the belt 82 in the conveying direction and a relative speed difference between the belt 82 and the rollers 85 and 86 was adjusted to be not more than a predetermined value. Speed fluctuations of the belt 82, positional fluctuations of the end of the lip of the casting die 81, and positional fluctuations in the vertical directions of the belt 82 just below the casting die 81 were adjusted to satisfy predetermined values. Both side edge positions of the belt 82 were detected to control the position of the belt 82 such that a meandering of the belt 82 in a widthwise direction per one rotation was regulated to be 1.5 mm or less.

The heat transfer medium at the predetermined temperature was supplied through the roller 85 on the casting die 81 side. The temperature of the heat transfer medium supplied through the other roller 86 was controlled at an appropriate temperature to dry the casting film 24a. A surface temperature of a center area of the belt 82 just before the casting was controlled such that a temperature difference between the surface temperature and the temperature of both edge portions was kept at a predetermined value.

[Casting and Drying]

The temperature of the casting chamber 63 was controlled by the temperature controller 97. The air blowers 91 to 93 supplied air to the casting film 24a on the lower portion of the belt 82 so as to maintain the temperature of the casting film 24a at a predetermined value. Saturated temperature of the dry air and oxygen concentration in dry atmosphere around the belt 82 were maintained at predetermined values. Oxygen concentration was adjusted by substitution of nitrogen gas for air.

The casting film 24a was peeled off from the belt 82 as the film 62 while being supported by the peel roller 109 at the time the solvent ratio in the casting film 24a reaches 50 wt. % (dry measure). The weight percentage of the solvent content (dry measure) was an amount obtained by a mathematical expression {(x−y)/y}×100, when x was a film weight at the sampling, and y was a weight of the dried sampling film. To prevent peeling defects, peeling speed was adjusted with respect to the speed of the belt 82. The solvent vapor generated by drying of the casting film 24a was condensed and liquefied in the condenser 98 and recovered by the recovery device 99. The temperature of the condenser 98 was controlled at a predetermined value. The recovered solvent was processed so as to make the water content thereof not more than a predetermined value. Dry air, from which the solvent was removed, was heated again and reused. The film 62 was conveyed to the tenter 64 through the rollers 101a. In the transfer section 101, dry air was blown onto the film 62 from the air blower 102. A predetermined tension was applied to the film 62 in the transfer section 101.

[Tenter Conveyance, Drying, and Edge Slitting]

The film 62 was conveyed through the tenter 64 and dried by dry air while both edges of the film 62 were fixed by clips 64a. The clips 64a were cooled by the heat transfer medium. The clips 64a were conveyed using chains. Conditions in the tenter 64 were set such that the remaining solvent amount of the film 62 reaches a predetermined value when the film 62 was discharged from the tenter 64. The solvent vapor in the tenter 64 were condensed, liquefied, and recovered by the condenser (not shown). The condensed solvent was reused after the water content was dropped below a predetermined value.

When the film 62 is discharged from the tenter 64, the both edge portions of the film 62 were cut off with the use of the edge-slitting device 67.

[Subsequent Drying and Neutralization]

The film 62 was dried at a high temperature in the drying chamber 69. The drying chamber 69 was divided in four sections in the conveying direction of the film 62. Air blower (not shown) supplied dry air of a predetermined temperature to each section. Tension applied to the film 62 by the rollers 68 was controlled at a predetermined value. The film 62 was dried until the remaining solvent amount reaches a predetermined value. The rollers 68 were made of aluminum or carbon steel, and a surface thereof was hard chrome plated. The rollers 68 with smooth surfaces and those with matte surfaces processed by blasting were used.

The solvent gas contained in the dry air was removed and recovered by adsorption using the recovery device 106. An activated carbon was used as an adsorbent. Desorption was carried out using dried nitrogen. The recovered solvent is reused as a solvent for the dope preparation after the water content is reduced below a predetermined value. Since the dry air may contain plasticizers, UV absorbents, and other substances with high boiling points, such additives and substances were removed using a cooling device and a preadsorber for circulated reuse.

There was a transfer section (not shown) between the drying chamber 69 and the cooling chamber 71. Dry air at 110° C. was supplied to the transfer section. Then, the film 62 was conveyed to a moisture control chamber (not shown) to prevent curling in the film 62. In the moisture control chamber, air was directly blown onto the film 62.

[Knurling and Winding Conditions]

Thereafter, the film 62 was cooled in the cooling chamber 71. After the cooling, the side edge portions of the film 62 were cut off by a second edge-slitting device (not shown). The neutralization device 72 was disposed such that the charged voltage of the film 62 being conveyed was constantly in a range of −3 kV and +3 kV. Knurling was applied to the both side edges of the film 62 with the use of the pair of knurling rollers 73 which perform embossing to one of the surfaces of the each side edge of the film 62.

The film 62 was conveyed to the winding chamber 76 in which the inner temperature and moisture were controlled. An ionized air blower (a neutralization device) (not shown) is installed inside the winding chamber 76 so as to adjust the charged voltage in a range of −1.5 kV and +1.5 kV. Each tension at the start and the end of winding is set at a predetermined value. A so-called oscillation range which is a range of positional fluctuations of the film 62 during winding, and a periodicity of the positional fluctuations with respect to the winding shaft 107 were detected and controlled. Pressure of the press roller applied to the winding shaft 107 was set at a predetermined value. Looseness, wrinkles, and the positional fluctuations in winding did not occur in an impact test at 10 G. An appearance of the film roll was excellent.

The film roll was stored in a storage rack at 25° C. and relative humidity of 55% (hereinafter described as 55% RH) for one month. Then, the inspection was performed in the same manner as the above. The results remained unchanged. There was no adhesion of film 62 in the film roll. After the production of the film 62, there was no remainder of the casting film 24a on the belt 82 through visual inspection.

Two polarizing filters were arranged in a crossed Nichol state. A sample of each film is sandwiched between the polarizing filters. A protection film of the polarizing filter is made of glass. A light is radiated from one surface side of the polarizing filter and the number of the bright dots was counted from the other side of the polarizing filter using an optical microscope (50×). The number of the bright dots with the diameter of not less than 0.01 mm per 1 cm² was counted. The following evaluation was made and the evaluation results are described in “Results” of Table 1 below.
A (Excellent): the number of bright dots per 1 cm² was zero to 9.
F (Failure): the number of bright dots per 1 cm² was 10 or more.

TABLE 1

Cellulose

| | Ca content | Mg Content | |
|---|---|---|---|
| | (ppm) | (ppm) | Results |
| Experiment 1 | 10.0 | 10.0 | A |
| Experiment 2 | 5.0 | 10.0 | A |
| Experiment 3 | 0.0 | 10.0 | A |
| Comparative | 30 | 20 | F |
| experiment 1 | | | |
| Comparative | 20 | 100 | F |
| experiment 2 | | | |

As described in the above examples, when the cellulose acylate is synthesized by esterification of cellulose, which has the Ca content of at most 10 ppm, with carboxylic acid, and the film is produced from the cellulose acylate, such film has substantially reduced number of bright dots compared to the film produced from cellulose having the Ca content of more than 10 ppm. Thus, according to the present invention, the cellulose acylate film which prevents depressions on the PVA layer and the liquid crystal layer, which are applied to the cellulose acylate film, is produced. As a result, the high-luminance and large-sized screen of the LCD using the cellulose acylate film exhibits excellent display performance.

Although the present invention has been fully described by the way of the preferred embodiments thereof with reference to the accompanying drawings, various changes and modifications will be apparent to those having skill in this field. Therefore, unless otherwise these changes and modifications depart from the scope of the present invention, they should be construed as included therein.

What is claimed is:

1. A producing method for cellulose acylate film comprising the steps of:
synthesizing cellulose acylate by esterification of cellulose with carboxylic acid, said cellulose having a calcium content of at most 10 ppm;
preparing a dope by dissolving said cellulose acylate in a solvent;
forming a casting film by continuously casting said dope onto a support; and
peeling said casting film from said support and drying said peeled casting film.

2. The producing method of claim 1, wherein sulfuric acid is used as a catalyst in said esterification, and said sulfuric acid and said carboxylic acid are neutralized with Ca(OH)₂ after said esterification.
